(19) United States
(12) Patent Application Publication
(10) Pub. No.: US 2015/0215291 A1
(43) Pub. Date: Jul. 30, 2015

(54) SECURE DECENTRALIZED CONTENT MANAGEMENT PLATFORM AND TRANSPARENT GATEWAY

(71) Applicants: Tarek A.M. Abdunabi, Kitchener (CA); Otman A Basir, Waterloo (CA)

(72) Inventors: Tarek A.M. Abdunabi, Kitchener (CA); Otman A Basir, Waterloo (CA)

(21) Appl. No.: 14/561,901

(22) Filed: Dec. 5, 2014

Related U.S. Application Data
(60) Provisional application No. 61/912,247, filed on Dec. 5, 2013.

(51) Int. Cl. H04L 29/06; H04W 12/04; G06F 21/62; H04W 12/02

(52) U.S. Cl. CPC H04L 63/0428; H04W 12/02; H04W 12/04; G06F 21/6263; H04L 63/08; H04L 63/061

(57) ABSTRACT

An apparatus and method for private, peer-to-peer, and end-to-end content delivery, management, and access is disclosed. Content examples may include encrypted email, Instant Messaging (IM), and Voice over Internet Protocol (VoIP) communications. The disclosed apparatus, hereafter referred to as Personal Portable Device, is a small device that is owned by the service's subscribers. A Personal Portable Device is connected to its owner's home Internet router via Ethernet cable (or Wi-Fi). Then, the Internet router is configured to forward ports on the Personal Portable Device to allow incoming requests. In one embodiment, two (or more) owners of the Personal Portable Devices communicate securely over the Internet. Each device acts as a standalone web server with email, IM, and VoIP servers. Portable Personal Devices communicate with each other over the Internet in peer-to-peer fashion, and automatically handle the generation and exchange of encryption/decryption keys.

### BACKGROUND

Concerns about the security and privacy of electronic communications over the Internet, especially emails, have grown in recent years. This is due to the increased attempts by third parties, such as intelligence agencies and hackers, to gain unauthorized access to private and/or official communications of domestic and foreign companies/individuals. Many non-secure free email service providers scan and read every email messages for information to sell to advertisers. Another problem faced by the users of email services provided by employers (e.g. organizations, companies, etc.) is that system administrators have complete access to email accounts and credentials, which allows them to read, edit, and/or delete email messages, or even send emails using users' accounts without their knowledge.

To address the security of email messages, several encryption/decryption systems have been utilized. These prior art systems can be generally categorized into software-based, and server-based encryption/decryption systems.

FIG. 1A shows one prior art software-based email encryption system 300, where the users of client machine 1 101 and client machine 2 102 are connected to an Email Server (Gmail, Yahoo, Hotmail, etc.) 104 over the Internet 3000 via communication links 105 and 106 respectively. In order for the two users to communicate by secure email, Encryption/Decryption Software 103 is installed on both client machines 101 and 102. Then, users are required to configure several settings in the Encryption/Decryption Software 103, such as encryption/decryption algorithms, keys generation, and keys exchange protocols. The process 400 of sending a secure email from the user of client machine 1 101 to the user of client machine 2 102 (or vice versa) is illustrated by the flowchart shown in FIG. 1B. In step 107 of process 400, the user of client machine 1 101 (or client machine 2 102) composes an email, and encrypts it locally using the Encryption/Decryption Software 103. In step 108, the encrypted email is sent to the Email Server 104. The user of client machine 2 102 (or client machine 1 101) downloads the encrypted email from the Email Server 104 in step 109. Finally, in step 110, the encrypted email is decrypted locally using the same Encryption/Decryption Software 103. However, software-based encryption systems require additional software, and advanced knowledge to configure and operate. Consequently, these systems are too complex for the average user to adopt.

Server-based encryption/decryption systems were introduced, to overcome the complexity of software-based encryption/decryption systems. FIG. 2A shows a prior art server-based email encryption/decryption system 500 disclosed in US patents owned by PGP Corporation, Palo Alto, Calif. These patents include: Callas et al., “System and Method for Secure and Transparent Electronic Communication”, pub. no. US 2004/0133520 A1, pub. date Jul. 8, 2004; “System and Method for Dynamic Data Security Operations”, pub. no. US2004/0133774A1, pub. date Jul. 8, 2004; and “System and Method for Secure Electronic Communication in a Partially Keyless Environment”, patent no. US7,640,427B2, pub. date Dec. 24, 2009. In one embodiment of this prior art system, an Encryption/decryption server 111 sets between the two client machines 101 and 102, and the Email Server (Gmail, Yahoo, Hotmail, etc.) 104. The client machines 101 and 102 communicate with the Encryption/Decryption Server 111 over Internet, LAN, or WAN 3100 using secure communication links 112 and 113. Encryption/Decryption Server 111 acts as a proxy (or gateway) for the client machines 101 and 102, and communicates with the Email Server 104 over the Internet 3000 using the communication link 114. The process 600 of sending a secure email from the user of client machine 1 101 to the user of client machine 2 102 (or vice versa) is illustrated by the flowchart shown in FIG. 2B. In step 115 of process 600, the user of client machine 1 101 (or client machine 2 102) connects remotely to the Encryption/Decryption Server 111 to compose emails. In step 116, the composed email is automatically encrypted by the Encryption/Decryption Server 111, and sent via Internet 3000 to the Email Server 104. In step 117, the recipient of the encrypted email, the user of client machine 2 102 (or Client Machine 1 101) connects remotely to the Encryption/Decryption Server 111 to read emails. Finally, in step 118, the encrypted email is automatically retrieved (from the Email Server 104), and decrypted by the Encryption/Decryption Server 111.

Another prior art server-based secure email system 700 is shown in FIG. 3A. This prior art system is disclosed by West in the patent “Secure Encrypted Email Server”, pub. no. U.S. Pat. No. 8,327,157 B2, pub. date Dec. 4, 2012. In this system, the Secure Email Server 119 handles encryption/decryption, and provides standalone email service to the users of client machines 101 and 102. Client machines 101 and 102 communicate with the Secure Email Server 119 over Internet 3000 using secure communication links 120 and 121. FIG. 3B shows a flowchart, which illustrates the process 800 of sending a secure email from the user of client machine 1 101 to the user of Client Machine 2 102 (or vice versa) using the service provided by the Secure Email Server 119. In step 122 of process 800, the user of Client Machine 1 101 (or Client Machine 2 102) connects remotely to the Secure Email Server 119 to compose emails. In step 123, the composed email is automatically encrypted and stored by the Secure Email Server 119. In step 123, the recipient of the encrypted email, the user of client machine 2 102 (or Client Machine 1 101) connects remotely to the Secure Email Server 119 to read emails. Finally, in step 125, the encrypted email is automatically decrypted by the Secure Email Server 119.

Even with using server-based encryption/decryption systems to secure emails, existing secure email services still encounter three major security risks. Firstly, storing large amount of encrypted email messages, using the same encryption keys, results in detectable repetitive patterns, which are easily breakable by third parties, using cryptanalysis techniques. Secondly, the employees of the secure email service provider have access to all customers' email messages and encryption keys, which allows them to read these messages without the knowledge of their customers. Thirdly, the secure email service providers may be forced by government agencies to hand over unencrypted email messages of their customers. Moreover, the identity of the email sender and receiver are not encrypted, which violates customers' privacy. What is needed is a secure email service that eliminates these three major security risks, and protects the privacy of its customers.

In view of the above, there exists a need for a communication system that allows private, peer-to-peer, and end-to-end encrypted communications, which are not easily breakable by cryptanalysis techniques, accessible by the service provider's employees, or under the control of government agencies. Further, a need exists for an easy-to-use, secure communication system that automatically handles encryption/decryption keys' generation and exchange.

### SUMMARY

The main objective of the present invention is to provide an apparatus and system for private, peer-to-peer, and end-to-end content delivery, management, and access, where the content may be generated by encrypted email, Instant Messaging (IM), and Voice over Internet Protocol (VoIP) services. The disclosed apparatus, hereafter referred to as Personal Portable Device (or Network Appliance), is a small device that is typically owned by the services subscribers.

In one embodiment of the present invention, major hardware and software components of the Personal Portable Device may include: Central Processing Unit (CPU), web server, SMTP (Simple Mail Transfer Protocol), POP (Post Office Protocol), VoIP Server, IM Server, DNS (Domain Name System), cryptography engine, RTOS (Real Time Operating System), storage (memory), SD Card, RAM, network interface, and power interface. In an alternative embodiment of the present invention, these hardware and software components may be embedded directly in an Internet router.

A Personal Portable Device owned by one subscriber, hereafter is referred to as User1, is connected to his home Internet router via Ethernet cable (or Wi-Fi). Then, the Internet router is configured to forward ports on the Personal Portable Device to allow incoming requests. User1 accesses his Personal Portable Device over Internet, LAN, or WAN using a secure communication link (via a web browser, software client, or mobile application). In one preferred embodiment of the present invention, two (or more) owners of the Personal Portable Devices communicate securely over the Internet. Each device acts as a standalone web server with email, IM, and VoIP servers. Portable Personal Devices communicate with each other over the Internet in peer-to-peer fashion, and automatically handle the generation and exchange of encryption/decryption keys. The sender's Personal Portable Device automatically encrypts his email, instant, and voice messages at one end, before it sends them over the Internet to the recipient's Personal Portable Device. Then, the received messages are decrypted at the other end by the recipient's Personal Portable Device.

In another embodiment of the present invention, a number of users may communicate securely over the Internet using the same Personal Portable Device. The owner of the Personal Portable Device creates N email accounts to be used by N different users. Each created account has its own folders. To send a secure email, a user logins remotely to the Personal Portable Device over Internet, using a secure communication link. The composed email is automatically encrypted and stored locally in the folder assigned to the intended email recipient. Then, the intended recipient logins securely to the same Personal Portable Device to read automatically decrypted emails.

For completeness, the present invention may allow communication between a Personal Portable Device, and a regular (unsecure) email server (Gmail, Yahoo, Hotmail, etc.). In this embodiment, all communications are performed without encryption. However, Personal Portable Devices may be configured to allow only secure communications between themselves.

In another embodiment of the present invention, two (or more) owners of Personal Portable Devices may similarly establish secure instant messaging, and/or VoIP sessions.

The Personal Portable Device may be configured to create encrypted (or unencrypted) backups for emails, address book, and encryption keys, to be stored on a cloud account, SD card, or/and personal computer.

As an additional security measure against a situation where the owner of a Personal Portable Device is forced to give up his/her password to reveal encrypted communications, the owner of a Personal Portable Device may create a second password (e.g. a self-destruct password) that when entered some/all encrypted communications and contacts are automatically deleted before an access to the Personal Portable Device is granted. The self destruction process may be configured in advance to include only important encrypted communications (e.g. special folders) and contacts to make the process unnoticeable.

Finally, the system provides controls for the sender of content to specify and automatically enforce its lifespan where the content is permanently removed. Similarly, the system provides controls for the recipient of content to specify and automatically enforce its lifespan where the content is permanently removed or archived.

### BRIEF DESCRIPTION OF THE DRAWINGS

The invention is more fully appreciated in connection with the following detailed description taken in conjunction with the accompanying drawings, in which:

FIG. 1A illustrates a network of a prior art software-based email encryption/decryption system.

FIG. 1B shows a flowchart that illustrates the process involved in the prior art software-based email encryption/decryption system.

FIG. 2A illustrates a network of a prior art server-based email encryption/decryption system, which acts as a proxy (or gateway) between the sender/receiver and the email server.

FIG. 2B shows a flowchart that illustrates the process involved in the prior art server-based email encryption/decryption system.

FIG. 3A illustrates a network of a prior art server-based secure email system, which performs the encryption/decryption and provides email service to its subscribers.

FIG. 3B shows a flowchart that illustrates the process involved in the prior art server-based secure email system.

FIG. 4A illustrates a network of the present invention, in which User1's Personal Portable Device (located at User1's home) is connected to his home router. User1 securely connects to his device (via Internet, LAN, or WAN) using PC, Tablet, or Smartphone.

FIG. 4B shows a flowchart that illustrates the process involved in the present invention to configure and access the Personal Portable Device.

FIG. 5A illustrates a network of one embodiment of the present invention, in which two owners of the Personal Portable Devices communicate securely over the Internet.

FIG. 5B shows a flowchart that illustrates the process involved in order for two owners of the Personal Portable Devices to communicate securely over the Internet.

FIG. 6A illustrates a network of another embodiment of the present invention, in which a number of users communicate securely over the Internet using the same Personal Portable Device.

FIG. 6B shows a flowchart that illustrates the process involved in order for a number of users to communicate securely over the Internet using the same Personal Portable Device.

FIG. 7A illustrates a network of another embodiment of the present invention, in which owner of the Personal Portable Device communicates with regular (unsecure) email servers.

FIG. 7B shows a flowchart that illustrates the process involved in order for User1 (the owner of a Personal Portable Device) to send emails to User2 (the user of regular (unsecure) email service).

FIG. 7C shows a flowchart that illustrates the process involved in order for User2 (the user of regular (unsecure) email service) to send emails to User1 (the owner of a Personal Portable Device).

FIG. 8 shows a block diagram that presents the major components of the Personal Portable Device.

FIG. 9 shows a flowchart that illustrates the process of sending secure emails (from one owner of the Personal Portable Device to another), and unsecure emails to regular email servers.

FIG. 10 shows a flowchart that illustrates the process of reading secure and unsecure emails received by a Portable Personal Device.

FIG. 11 shows a flowchart that illustrates the process of establishing secure Instant Messaging (IM), and/or Voice over Internet Protocol (VoIP) sessions between two (or more) owners of Portable Personal Devices.

FIG. 12 shows a flowchart that illustrates the process of creating encrypted/unencrypted backups for the Portable Personal Device (including emails, address book, and encryption keys) to be stored on a cloud account, SD card, or/and personal computer.

FIG. 13 shows a flowchart that illustrates the process of self destruction in case the owner of a Personal Portable Device is forced to give up his/her password to reveal encrypted communications and contacts.

FIG. 14 shows a flowchart that illustrates the process of specifying a lifespan to the content by the sender to automatically enforce its permanent removal from the recipient's device.

FIG. 15 shows a flowchart that illustrates the process of specifying a lifespan to the received content by the recipient to automatically enforce its permanent removal or archival.

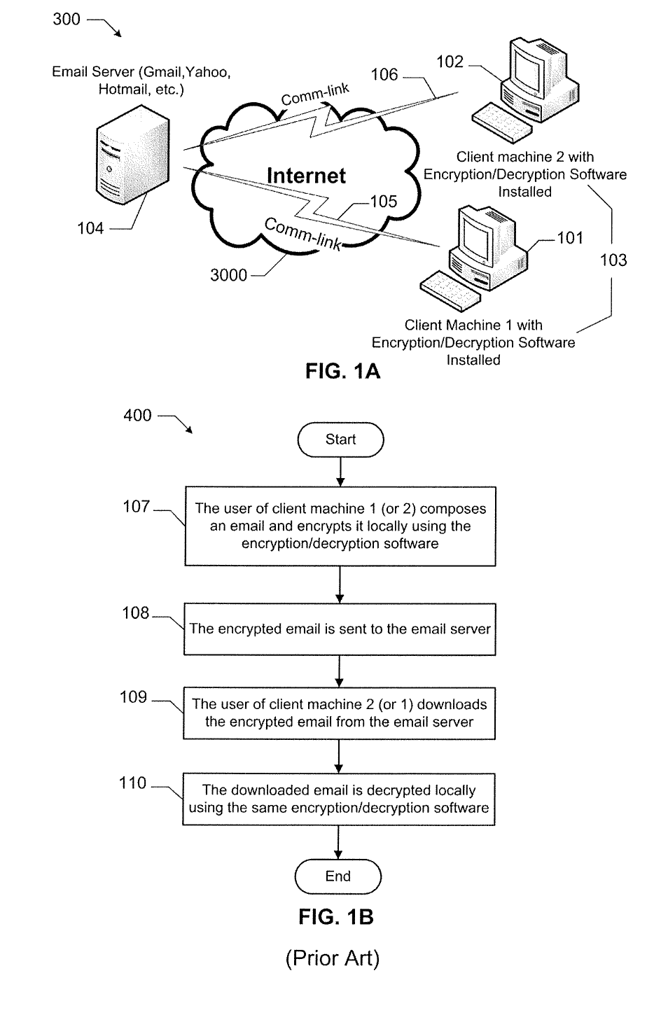

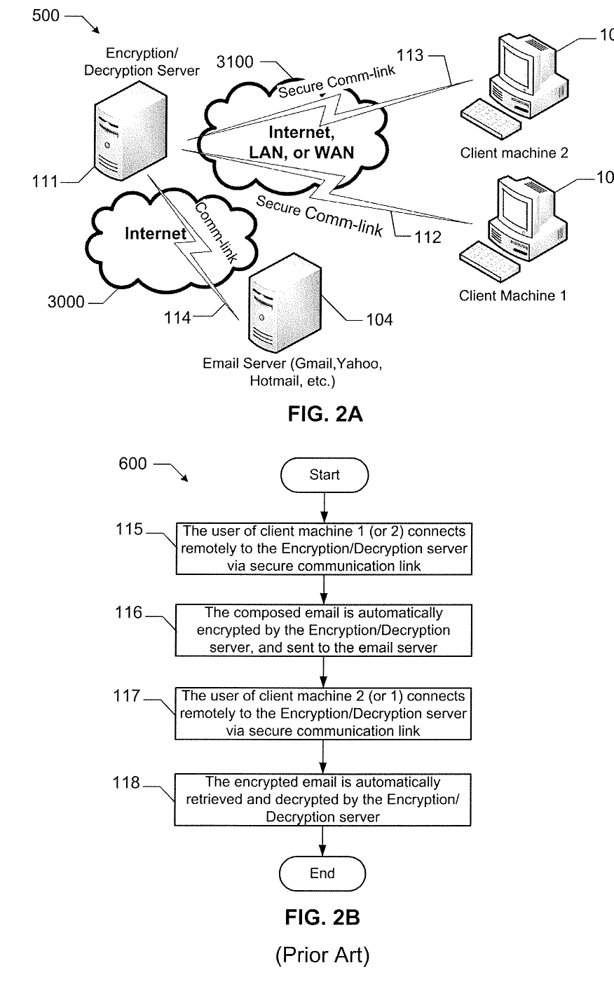

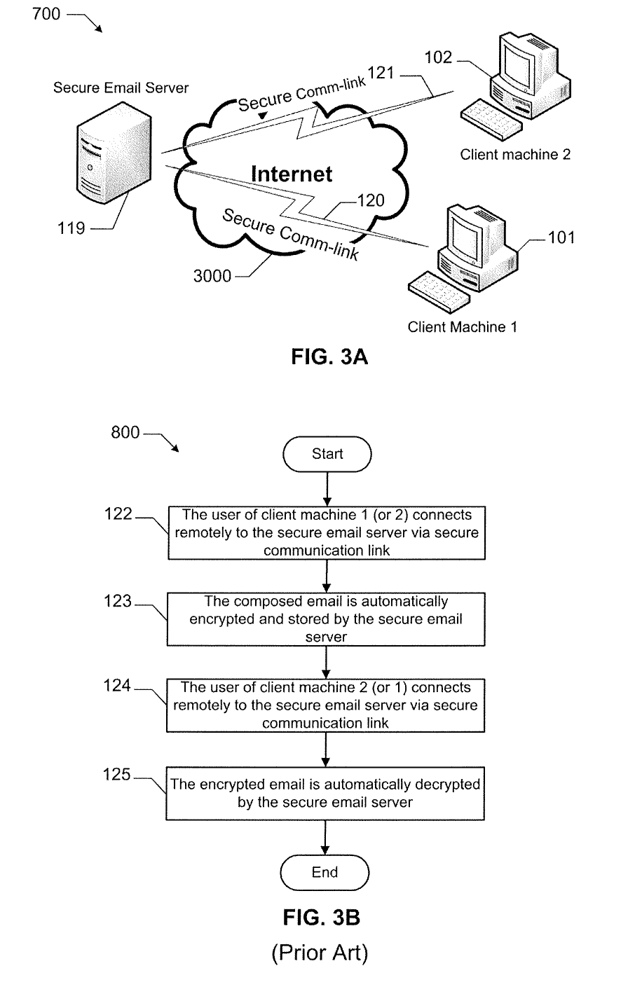

### DETAILED DESCRIPTION

The following is a detailed description of the preferred embodiments, reference being made to the drawings in which the same reference numerals identify the same elements of structure in each of the several figures. Numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, specific details, and the like have been omitted inasmuch as such details are not considered necessary to obtain a complete understanding of the present invention, and are considered to be within the understanding of persons of ordinary skill in the relevant art.

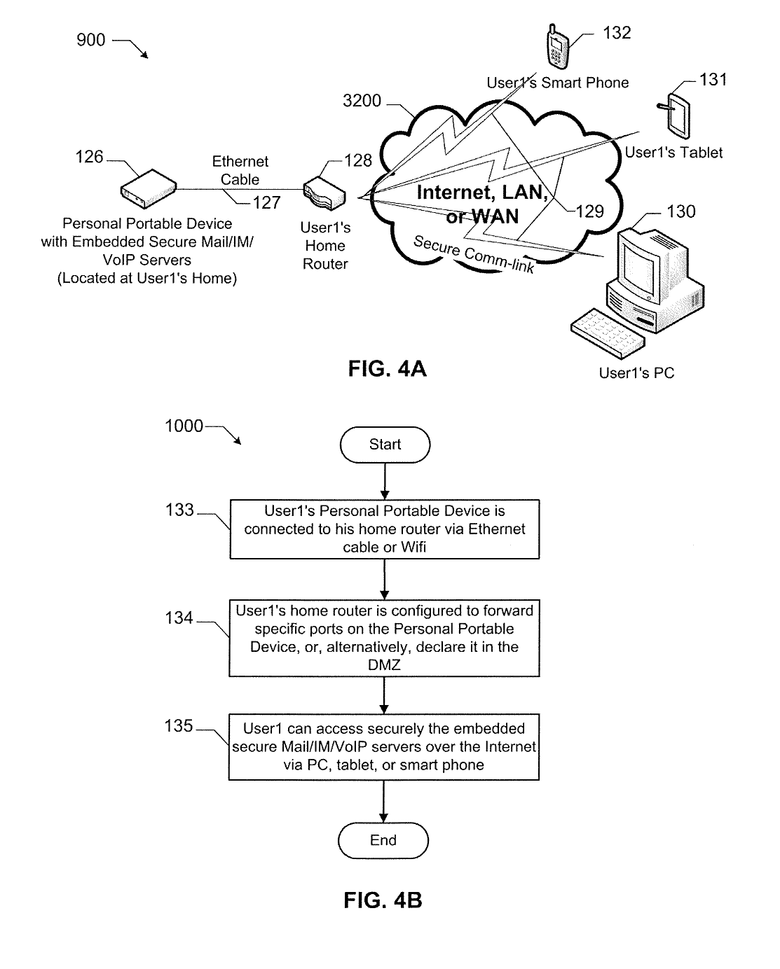

FIG. 4A illustrates a network 900, in which User1's Personal Portable Device 126 (located at User1's home) is connected to his home router 128. User1 connects to his device 126 over Internet, LAN, or WAN 3200 using PC 130, Tablet 131, or Smartphone 132, via secure communication link 129. FIG. 4B shows a flowchart that illustrates the process 1000 involved in the present invention to configure and access the Personal Portable Device 126. In step 133 of process 1000, User1's Personal Portable Device 126 is connected to his home router 128 via Ethernet cable 127 or Wi-Fi. In step 134, User1's home router 127 is configured to forward specific ports on the Personal Portable Device 126, or alternatively, declare the Personal Portable Device 126 in the Demilitarized Zone (DMZ). Finally, in step 135, User1 can access the embedded secure Mail/IM/VoIP servers on his Personal Portable Device 126 over Internet, LAN, or WAN 3200, using his PC 130, Tablet 131, or Smartphone 132, via a secure communication link 129.

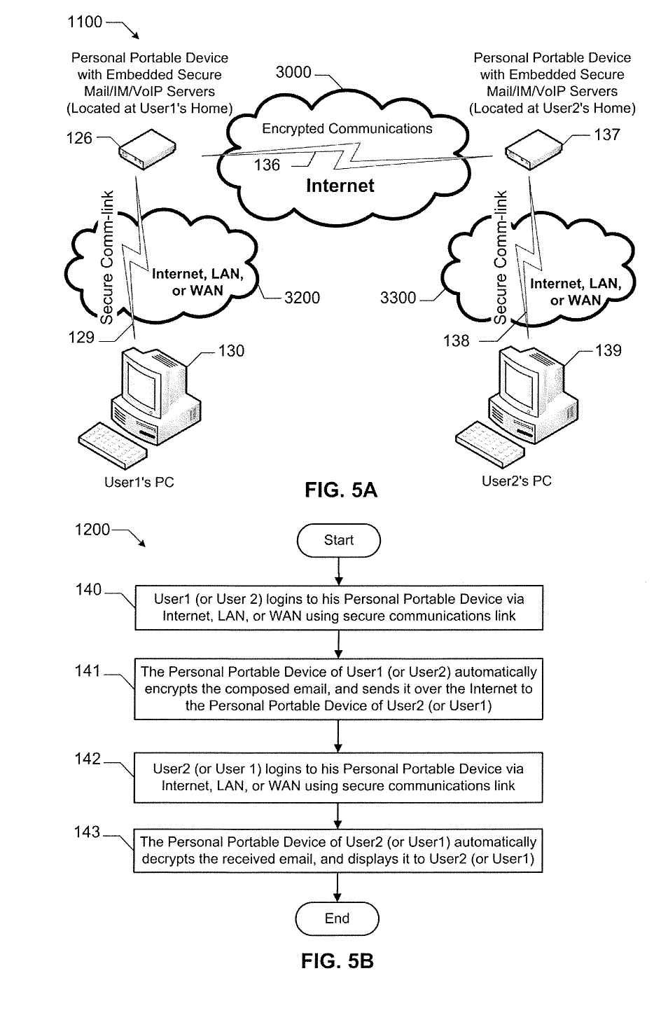

FIG. 5A illustrates a network 1100 of one embodiment of the present invention, in which two owners of Personal Portable Devices communicate securely over the Internet. In This network 1100, User1 130 connects to his Personal Portable Devices 126 over Internet, LAN, or WAN 3200, via secure communication link 129. User2 139 connects to his Personal Portable Devices 137 over Internet, LAN, or WAN 3300, via secure communication link 138. The two Personal Portable Devices 126 and 137 exchange encrypted communications 136 over Internet 3000. FIG. 5B shows a flowchart that illustrates the process 1200 involved in order for two owners of the Personal Portable Devices to communicate securely over the Internet. In step 140 of process 1200, User1 130 (or User2 139) logins to his Personal Portable Device 126 (or 137). In step 141, the Personal Portable Device of the sender 126 (or 137), automatically encrypts the composed email, and sends it over Internet 3000, to the Personal Portable Device of the receiver 137 (or 126). In step 142, User2 139 (or User1 130) logins to his Personal Portable Device 137 (or 126). Finally, in step 143, the Personal Portable Device of the receiver 137 (or 126), automatically decrypts the received email, and displays it to User2 139 (or User1 130). The generation and exchange of encryption/decryption keys are handled automatically by the Personal Portable Devices.

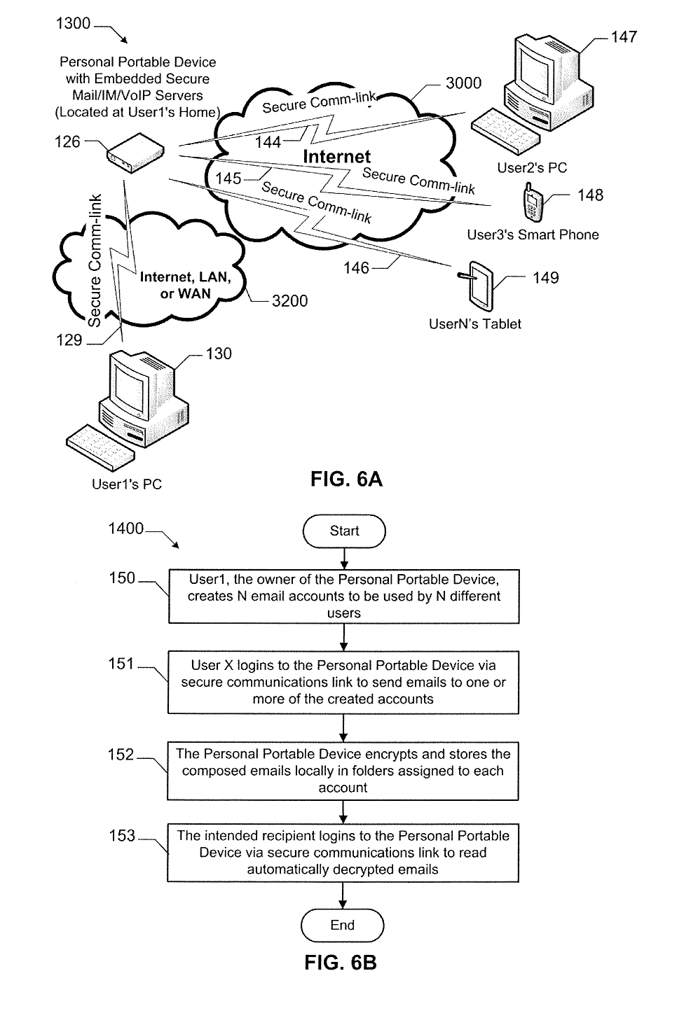

FIG. 6A illustrates a network 1300 of another embodiment, in which a number of users communicate securely over the Internet, using the same Personal Portable Device. In network 1300, User1 130 connects to his Personal Portable Devices 126 over Internet, LAN, or WAN 3200 via secure communication link 129. User2 147, User3 148, and UserN 149 connect to User1's Personal Portable Devices 126 over Internet 3000, using secure communication links 144, 145, and 146 respectively. FIG. 6B shows a flowchart that illustrates the process 1400 involved in order for a number of users to communicate securely over the Internet, using the same Personal Portable Device. In step 150 of process 1300, User1 130, the owner of the Personal Portable Device 126, creates N Mail/IM/VoIP accounts to be used by N different users (User2 147, User3 148, and UserN 149). Each created account has its own folders. To send a secure email, in Step 151, User2 147, User3 148, or UserN logins to User1's Personal Portable Device 126. In step 152, User1's Personal Portable Device 126 automatically encrypts the composed email and stores it locally in the folder assigned to the intended email recipient. Finally, in step 153, the intended email recipient logins securely to User1's Personal Portable Device 126 to read automatically decrypted emails.

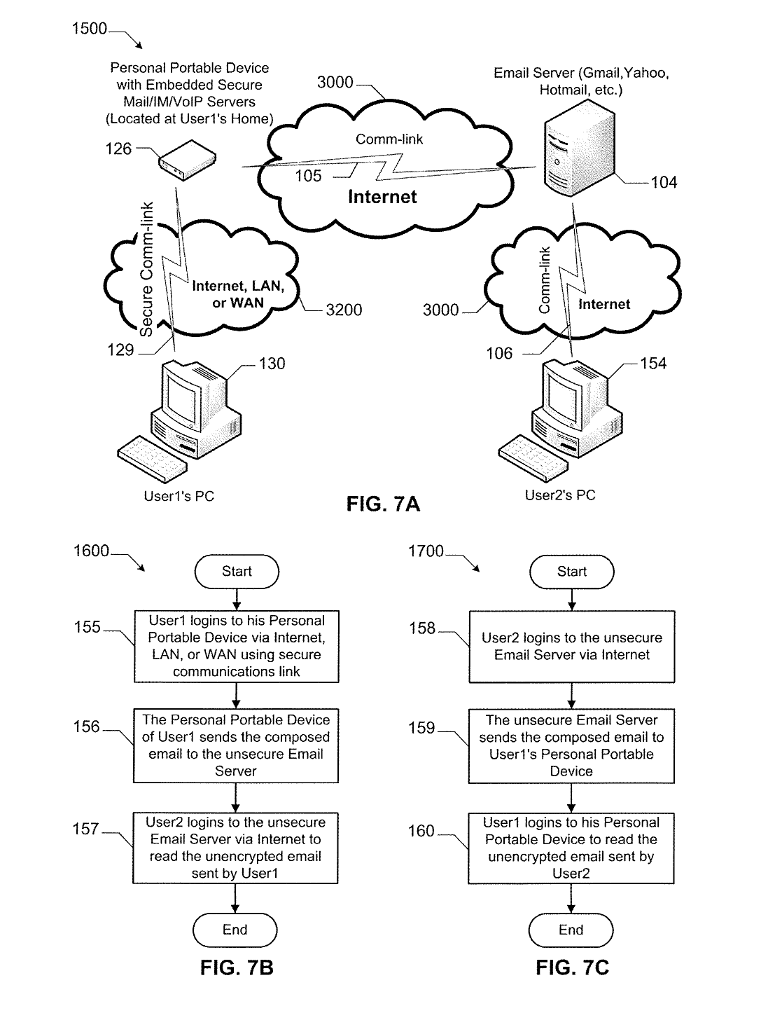

FIG. 7A illustrates a network 1500 of another embodiment, in which the owner of a Personal Portable Device communicates with a regular (unsecure) email server. In network 1500, User1 130 connects to his Personal Portable Devices 126 over Internet, LAN, or WAN 3200 via secure communication link 129. User2 154 connects to Email Server (Gmail, Yahoo, Hotmail, etc.) 104 over Internet 3000 via communication link 106. Personal Portable Devices 126 and Email Server 104 communicate over Internet 3000 via communication link 105. FIG. 7B shows a flowchart that illustrates the process 1600 involved in order for User1 130 to send unencrypted emails to User2 154. In step 155 of process 1600, User1 130 logins to his Personal Portable Devices 126 to compose an email to User2 154. In step 156, User1's Personal Portable Device 126 sends the composed email to the Email Server 104. Finally, in step 157, User2 154 logins to the Email Server 104 to read the email sent by User1 130. FIG. 7C shows a flowchart that illustrates the process 1700 involved in order for User2 154 to send unencrypted emails to User1 130. In step 158 of process 1700, User2 154 logins to the Email Server 104 to compose an email to User1 130. In step 159, the Email Server 104 sends the composed email to User1's Personal Portable Device 126. Finally, in step 160, User1 130 logins to his Personal Portable Devices 126 to read the email sent by User2 154.

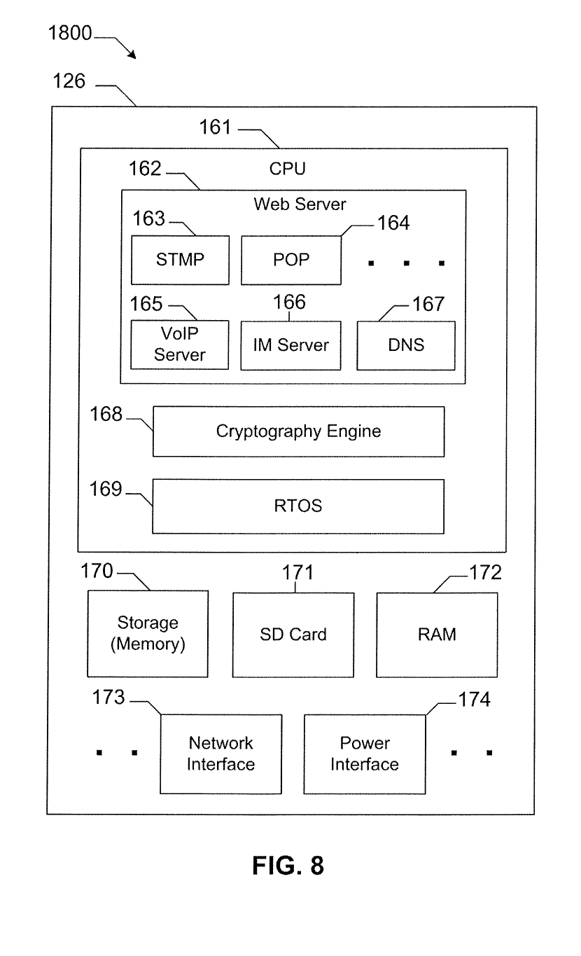

FIG. 8 shows a block diagram 1800 that presents the major components of the Personal Portable Device 126. Hardware and software components provide the required functionalities for private, peer-to-peer, and end-to-end encrypted communications. In one embodiment, major components may include: Central Processing Unit (CPU) 161, Web Server 162, SMTP (Simple Mail Transfer Protocol) 163, POP (Post Office Protocol) 164, VoIP Server 165, IM Server 166, DNS (Domain Name System) 167, Cryptography Engine 168, RTOS (Real Time Operating System) 169, Storage (memory) 170, SD Card 171, RAM 172, Network Interface 173, and Power Interface 174. In an alternative embodiment, these hardware and software components may be embedded directly in an Internet router.

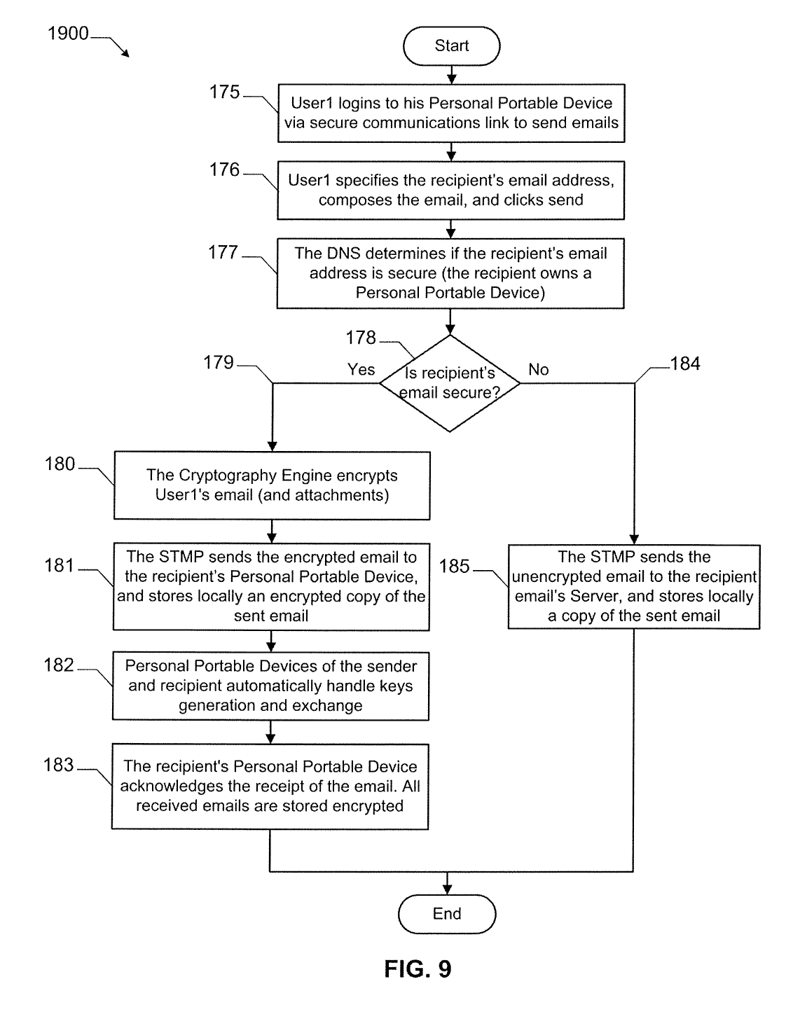

FIG. 9 shows a flowchart that illustrates the process 1900 of sending secure emails (from one owner of a Personal Portable Device to another), and unsecure emails to regular email servers. In step 175 of process 1900, User1 130 logins to his Personal Portable Devices 126 to send emails. In step 176, User1 130, specifies the recipient's email address, composes the email, and clicks send. Next in step 177, the DNS 167 determines whether the recipient's email address is secure (the recipient owns a Personal Portable Device), or not (recipient uses a regular email service). The decision is taken in step 178. If the recipient's email address is not secure 184, the STMP 163 sends an unencrypted email to the recipient's Email Server 104, and stores locally a copy of the sent email. On the other hand, if the recipient's email address is secure 179, the Cryptography Engine 168 encrypts the composed email (and attachments) in step 180. Then in step 181, the STMP 163 sends the encrypted email to the recipient's Personal Portable Device 137, and stores locally an encrypted copy of the sent email. In step 182, Personal Portable Devices 126 and 137 of the sender and receiver automatically handle keys generation and exchange. Finally, in step 183, the recipient Personal Portable Device acknowledges the receipt of the email. All received emails are stored encrypted.

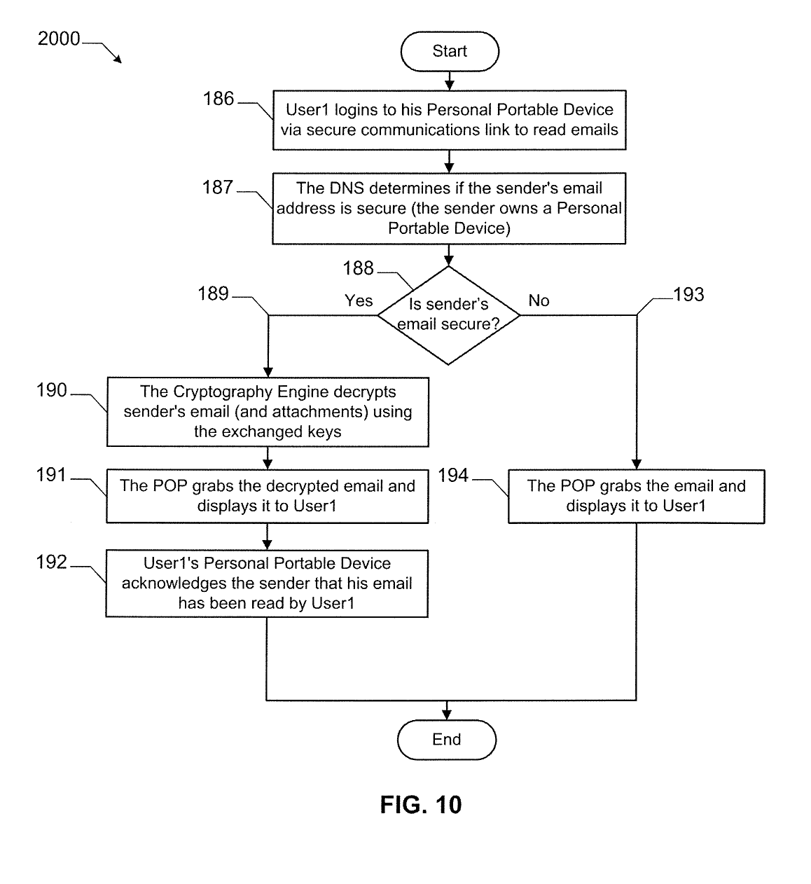

FIG. 10 shows a flowchart that illustrates the process 2000 of reading secure and unsecure emails received by the Portable Personal Device 126. In step 186 of process 2000, User1 130 logins to his Personal Portable Devices 126 to read emails. Then in step 187, the DNS 187 determines whether the sender's email address is secure or not. The decision is taken in step 188. If the sender's email address is not secure 193, the POP 164 grabs the received unencrypted email and display it to User1 130 in step 194. On the contrary, if the sender's email address is secure 189, the Cryptography Engine 168 decrypts the received email (and attachments) in step 190 using the exchanged keys. Then, in step 191, the POP 164 grabs the decrypted email and display it to User1 130. Finally, in step 192, User1's Personal Portable Device 126 acknowledges the sender that his email has been read by User1 130.

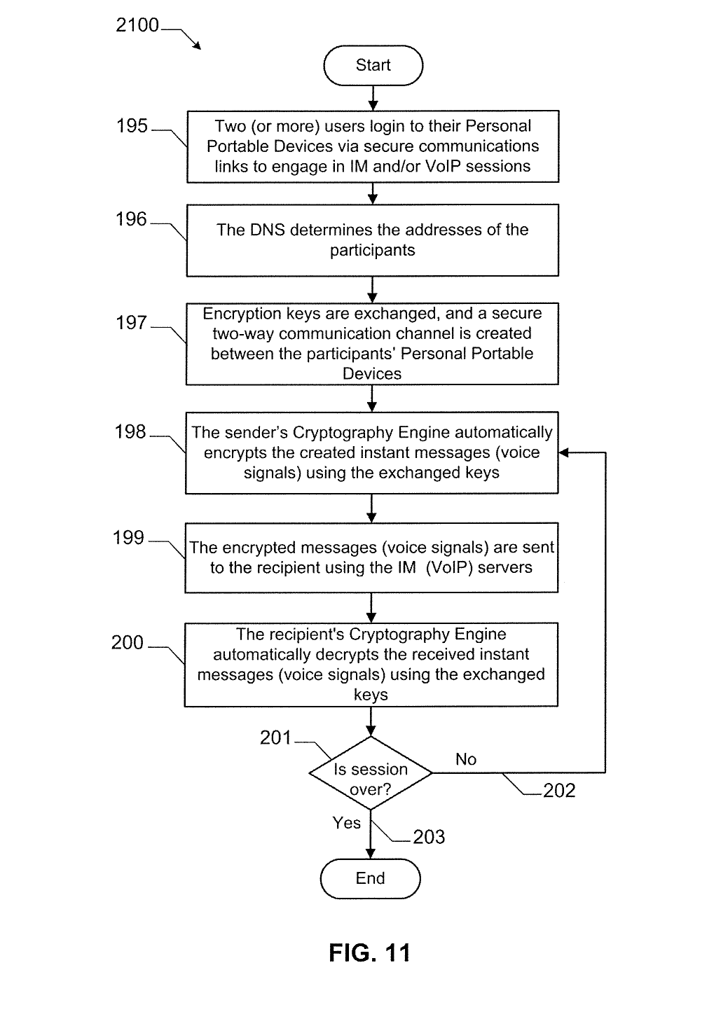

FIG. 11 shows a flowchart that illustrates the process 2100 of establishing secure Instant Messaging (IM), and/or Voice over Internet Protocol (VoIP) sessions between two (or more) owners of Portable Personal Devices. In step 195 of process 2100, two (or more) users login to their Personal Portable Devices via secure communication links. In step 196, the DNS 167 determines the addresses of the session's participants. Then in step 197, encryption/decryption keys are exchanged, and a secure two-way communication channel is created between the participants' Personal Portable Devices. In step 198, the sender's Cryptography Engine 168 automatically encrypts the created instant messages (voice signals) using the exchanged keys. In step 199, the encrypted messages (voice signals) are sent over the Internet 3000 to the recipient, using the Embedded IM Server 166 (Embedded VoIP Server 165). In step 200, the recipient's Cryptography Engine 168 automatically decrypts the received instant messages (voice signals) using the exchanged keys. If the decision is taken in step 201 to continue 202 the secure IM/VoIP session, the process returns back to step 198. Otherwise, the session is terminated 203.

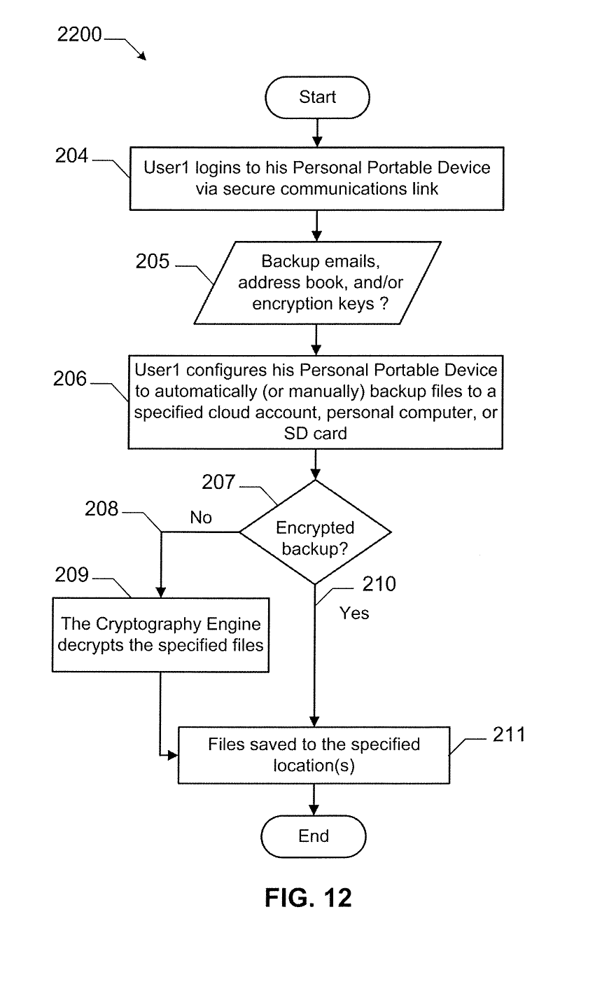

FIG. 12 shows a flowchart that illustrates the process 2200 of creating encrypted (or unencrypted) backups for the Portable Personal Device 126. Backups may include emails, address book, and/or encryption keys. The created backups may be stored on a cloud account, SD card, or/and personal computer. In step 204 of process 2200, User1 130 logins to his Personal Portable Device 126 over Internet, LAN, or WAN 3200, using secure communication link 129. In step 205, User1 130 decides to backup emails, address book, and/or encryption keys. In step 206, User1 130 configures his Personal Portable Device 126 to automatically (or manually) backup files to a specified cloud account, personal computer, or/and SD card. A decision is made in step 207 whether the backup is encrypted or unencrypted. If User1 130 decides his backup should remain encrypted 210, then back files are saved to the specified location(s) in step 211. On the other hand, if User1 130 decides his backup should be unencrypted 208, the Cryptography Engine 168 automatically decrypts files in step 209 before they are saved to the specified location(s) in step 211.

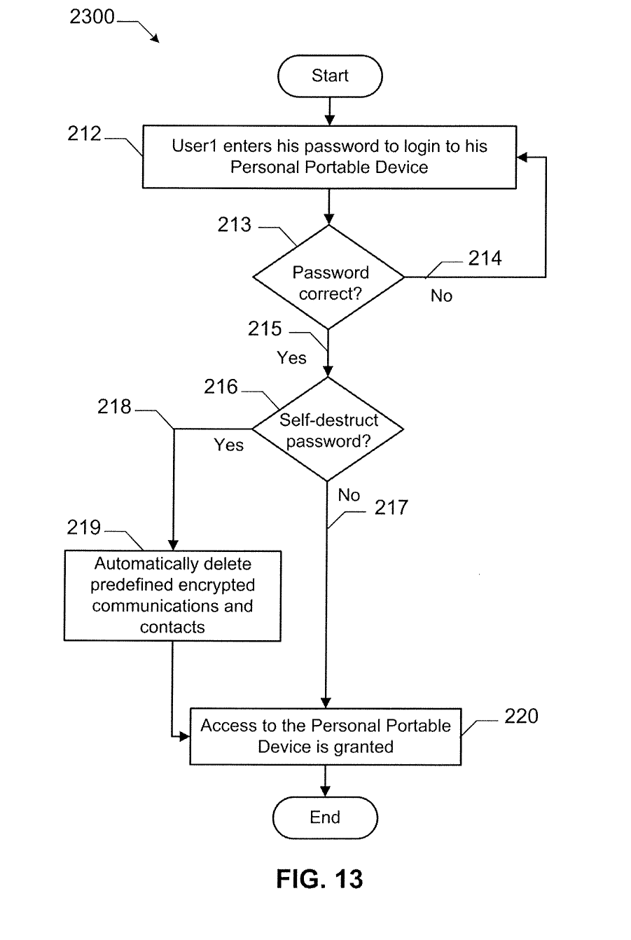

FIG. 13 shows a flowchart that illustrates the process 2300 of self destruction as an additional security measure against a situation where the owner of a Personal Portable Device 126 (e.g. User1) is forced to give up his/her password to reveal encrypted communications and contacts. The owner of a Personal Portable Device 126 may create a second password (e.g. a self-destruct password) that when entered some/all encrypted communications and contacts are automatically deleted before an access to the Personal Portable Device is granted. In step 212 of process 2300, User1 enters his password to login to his Personal Portable Device 126. The password is authenticated in step 213. If the entered password is wrong (does not match neither the main password nor the self-destruct password), User1 is directed back to step 212. Otherwise the process moves 215 to the next step. In step 216, the entered password is examined; if it is the self-destruct password 218, predefined encrypted communications and contacts are automatically deleted in step 219 before an access to the Personal Portable Device 126 is granted in step 220. On the other hand, if the entered password is not the self-destruct password (main password) 217, access to the Personal Portable Device 126 is immediately granted in step 220. The self destruction process may be configured in advance to include only important encrypted communications (e.g. special folders) and contacts to make the process unnoticeable.

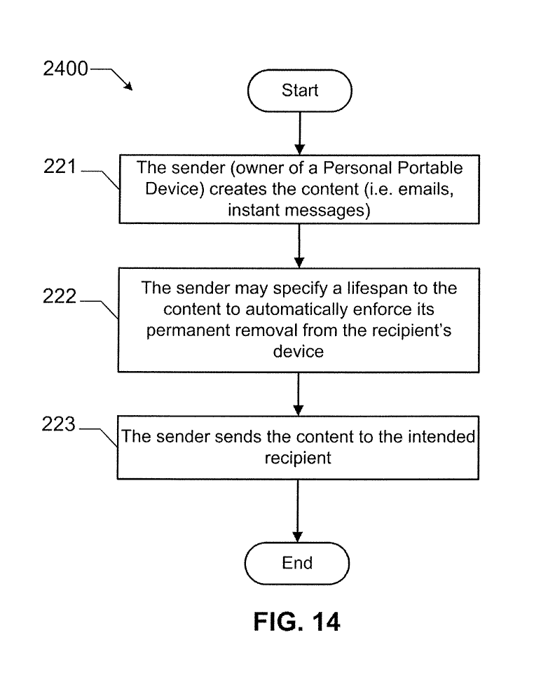

FIG. 14 shows a flowchart that illustrates the process 2400 of specifying a lifespan to the content by the sender. In step 221 of process 2400, the sender creates the content (i.e. email (with attachments), instant message). Then in step 222, the sender may specify a lifespan to the content to automatically enforce its permanent removal (from the recipient's device) at; (a) a specific date and time, (b) a specific duration after the content is accessed by the recipient, or (c) on the receipt or absence of receipt of a trigger from the sender. Finally, in step 223, the sender sends the created content to the intended recipient(s).

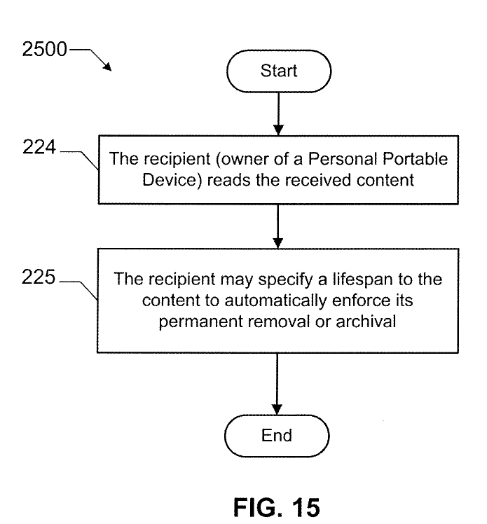

FIG. 15 shows a flowchart that illustrates the process 2500 of specifying a lifespan to the received content by the recipient. In step 224 of process 2500, the recipient reads the received content. Then in step 225, the recipient may specify a lifespan to the content to automatically enforce its permanent removal or archival at; (a) a specific date and time, or (b) a specific duration after the content is accessed.

What is claimed is:

1. A network communication system comprising:
first and second personal portable devices each including a CPU, web server and cryptography engine;
first and second email clients connected to the first and second personal portable devices, respectively, via secure connections;
the first personal portable device configured to receive communications from the first email client and to send the communications to the second personal portable device via a peer-to-peer connection, which is configured to deliver the communications to the second email client.

2. The network communication system of claim 1 wherein the first and second personal portable devices exchange encryption/decryption keys and the first personal portable device uses the keys to encrypt the communications before sending them to the second personal portable device, and the second personal portable device uses the keys to decrypt the communications.

3. A system for secure, decentralized network communication including:
a. interfaces for local and/or remote networks,
b. servers to accept, secure, share, and/or store-and-forward local or remote content, and
c. usage-based access controls.

4. The system in claim 3 wherein the security logic is encapsulated within a network appliance.

5. The system in claim 4 wherein the network appliance additionally provides network routing capabilities.

6. The system in claim 3 wherein network communication includes secure content, examples of which include store-and-forward message-based content (email, instant messaging), and streaming content (voice communication).

7. The system in claim 6 wherein secure content can be accessed from remote computer without installing software and without modification of the remote computer.

8. The system in claim 6 wherein one or more recipients of the content are known and authenticated with a compatible secure communication system, and secure content is transferred only to these authenticated recipients.

9. The system in claim 6 wherein one or more recipients of the content cannot be authenticated or do not have a compatible secure communication system, and information is transferred to these recipients with options to self-authenticate and access the content directly.

10. The system in claim 5 further providing secure communication channels transparently to connected computers, without requiring additional software to be installed on the connected computers.

11. The system in claim 6 further connected with a second system to form a secure point-to-point tunnel for communication.

12. The system in claim 9 wherein the self-authentication process is performed locally to access secured content (i.e. a secured message is delivered and remains secured until successfully authenticated, not just the instructions to remotely access the message).

13. The system in claim 6 further with one or more user accounts and automatic generation of user accounts for recipients of new content.

14. The system in claim 9 further providing options to send standard, unsecured content to recipients (fallback mechanism).

15. The system in claim 3 further providing archival options in local, remote, or distributed storage systems.

16. The system in claim 15 further providing secure wipe actions triggered by one or more of: remote trigger, false password, failed access attempts, or elapsed time without receiving a predetermined cue (keep-alive).

17. The system in claim 15 further providing controls for the sender of content to specify and automatically enforce its lifespan where the content is permanently removed at; (a) a specific date and time, (b) a specific duration after the content is accessed by the recipient, or (c) on the receipt or absence of receipt of a trigger from the sender.

18. The system in claim 15 further providing controls for the recipient of content to specify and automatically enforce its lifespan where the content is permanently removed or archived at; (a) a specific date and time, or (b) a specific duration after the content is accessed.

19. The system in claim 6 further providing controls for the sender of content to receive and/or monitor information about the state of the content, where state may include; in transit, delivered, opened, archived, deleted, forwarded, or permanently removed due to a trigger.
